(19) United States
(12) Patent Application Publication
(10) Pub. No.: US 2003/0174444 A1
(43) Pub. Date: Sep. 18, 2003

(54) Method and apparatus for controlling shape of a bearing surface of a slider

(76) Inventors: Youping Mei, Eden Prairie, MN (US); Peter Ross Goglia, Edina, MN (US); Jun Mou, Edina, MN (US); Mohamed Salah Houceine Khlif, Fridley, MN (US); Gordon Merle Jones, Eagan, MN (US)

Correspondence Address: Todd R. Fronek, WESTMAN CHAMPLIN & KELLY, International Centre, Suite 1600, 900 South Second Avenue, Minneapolis, MN, 55402-3319, US

(21) Appl. No.: 10/267,490

(22) Filed: Oct. 9, 2002

Related U.S. Application Data
(60) Provisional application No. 60/363,801, filed on Mar. 12, 2002.

(51) Int. Cl. G11B 5/60

(52) U.S. Cl. 360/236.6

(57) ABSTRACT

A method of controlling a shape of a bearing surface of a head slider is provided. The method includes obtaining a set of shape adjust patterns, wherein each pattern corresponds to a response in the shape of the bearing surface. Furthermore, the method includes generating a representation of the shape of the bearing surface of the slider. The representation includes a plurality of measurements of substantially the entire shape of the bearing surface wherein each measurement corresponds to a location on the bearing surface and a height of the associated location. Material stresses on a working surface of the slider are selectively altered within the obtained shape adjust patterns based on the representation in order to alter the shape of the bearing surface.

### CROSS-REFERENCE TO RELATED APPLICATION

This application claims benefit of U.S. Provisional Application No. 60/363,801 filed on Mar. 12, 2002 for inventors Youping Mei, Peter R. Goglia, Jun Mou, Mohamed Salah Khlif and Gordon M. Jones and entitled GROUPED SUBSPACE BASIS (GSB) METHOD FOR DISK HEAD FLATNESS CONTROL.

### FIELD OF THE INVENTION

The present invention relates generally to data storage systems, and more particularly but not by limitation to a method of controlling shape of a transducing head, such as a hydrodynamic bearing slider.

### BACKGROUND OF THE INVENTION

Disc drives of the “Winchester” type are well known in the industry. Such drives use rigid discs coated with a magnetizable medium for storage of digital information in a plurality of circular, concentric data tracks. The discs are mounted on a spindle motor, which causes the discs to spin and the surfaces of the discs to pass under respective head gimbal assemblies (HGAs). Head gimbal assemblies carry transducers, which write information to and read information from the disc surface. An actuator mechanism moves the head gimbal assemblies from track to track across the surfaces of the discs under control of electronic circuitry. The actuator mechanism includes a track accessing arm and a load beam for each head gimbal assembly. The load beam provides a preload force, which urges the head gimbal assembly toward the disc surface.

The head gimbal assembly includes a gimbal and a slider. The gimbal is positioned between the slider and the load beam to provide a resilient connection that allows the slider to pitch and roll while following the topography of the disc. The slider includes a slider body having a bearing surface, such as an air bearing surface, which faces the disc surface. As the disc rotates, the air pressure between the disc and the air bearing surface increases, which creates a hydrodynamic lifting force that causes the slider to lift and fly above the disc surface. The preload force supplied by the load beam counteracts the hydrodynamic lifting force. The preload force and the hydrodynamic lifting force reach an equilibrium, which determines the flying height of the slider. The transducer is typically mounted at or near the trailing edge of the slider.

In some applications, the slider flies in close proximity to the surface of the disc. This type of slider is known as a “pseudo-contact” slider. In other applications, the slider is designed to remain in direct contact with the disc surface with substantially no air bearing. These sliders are referred to as “contact recording” sliders.

It is often desirable to fabricate a slider such that the bearing surface has a positive curvature along the length and width of the slider. Length curvature is known as crown curvature. Width curvature is known as cross or camber curvature. The proper setting and control of crown and cross curvature improves flying height variability over varying conditions, improves wear on the slider and the disc surface, and improves takeoff performance by reducing stiction between the slider and the disc surface. In a typical slider fabrication process, crown or cross curvature is created by lapping the bearing surface on a spherically-shaped lapping surface or on a flat lapping surface while rocking the slider body back and forth in the direction of the desired curvature. The amount of curvature is determined by the radius of the rocking rotation. This lapping process is difficult to control and results in large manufacturing tolerances. More efficient and controllable methods of effecting air bearing surface curvature are desired.

U.S. Pat. No. 5,442,850 discloses a method of controlling curvature by inducing a preselected amount of compressive stress within a selected section of the bearing surface by impinging the section with particles for a preselected amount of time. U.S. Pat. No. 5,266,769 discloses a process of controlling slider curvature in which the air bearing surfaces are first patterned and then a chosen pattern of stress is produced on the back side of the slider by laser oblation or sand blasting to selectively remove stressed material and thereby create a desired crown and cross curvature of the bearing surface.

U.S. Pat. No. 4,910,621 discloses a method of producing curvature in a slider by creating a groove in the leading edge of the slider, placing a sealing material in the groove and then melting and stiffening the sealing material in the groove. The sealing material has an adhesive property upon melting and a shrinking property upon stiffening which causes lengthwise curvature at the leading edge of the slider. U.S. Pat. No. 5,220,471 discloses a slider having a longitudinal linear groove formed in a surface which is opposite the disc-opposing surface. The groove creates tensile stresses which cause the disc-opposing surface of the slider to be a curved surface in a convex form.

U.S. Pat. No. 5,982,583 discloses a method of effecting slider curvature through the application of laser-induced anisotropic tensile stress, which allows one of the crown and cross curvature to be changed to a greater extent than the other curvature. In addition, a process of creating scratches on the back side of the slider (the side opposite to the air bearing), lapping the bearing surface flat and then laser heat treating the scratches to reduce compressive stress caused by the scratches and thereby cause a positive curvature change in the bearing surface has been used. This process is discussed in U.S. Pat. No. 6,073,337.

While the above methods improve curvature control, these methods are still not entirely effective in accurately and independently achieving desired shape of a bearing surface of a slider. In particular, lower fly heights and increased density of data stored on discs has created the need for sliders having a particular shape on the bearing surface. The shape may not be indicative of either crown or cross curvature. Accordingly, a method is needed to precisely control the bearing surface shape. Additionally, a method is needed to fabricate sliders of reduced thickness. When working with sliders of reduced thickness, current fabrication methods are not able to provide shape change while preventing cracking and other undesirable effects of the sliders. Embodiments of the present invention address these and other problems, and offer other advantages over the prior art.

### SUMMARY OF THE INVENTION

A method of controlling a shape of a bearing surface of a head slider is provided. The method includes obtaining a set of shape adjust patterns, wherein each pattern corresponds to a response in the shape of the bearing surface. Furthermore, the method includes generating a representation of the shape of the bearing surface of the slider. The representation includes a plurality of measurements of substantially the entire shape of the bearing surface wherein each measurement corresponds to a location on the bearing surface and a height of the associated location. Material stresses on a working surface of the slider are selectively altered within the obtained shape adjust patterns based on the representation in order to alter the shape of the bearing surface.

Another aspect of the invention is a head slider. The slider includes a first surface having a shape defined by a collection of base shapes and a second surface opposite the first surface. A set of shape adjust patterns are included on the second surface, wherein each shape adjust pattern corresponds to one of the collection of base shapes. Additionally, a selected number of scan lines are formed within each of the shape adjust patterns on the second surface. Each scan line generates a degree of response on the bearing surface of one of the collection of base shapes associated with the shape adjust pattern.

An apparatus is also provided that controls the shape of a bearing surface of a slider. The apparatus utilizes a light source to alter material stresses in a working surface of the slider. The stresses are altered until a desired shape is achieved.

Other features and benefits that characterize embodiments of the present invention will be apparent upon reading the following detailed description and review of the associated drawings.

### BRIEF DESCRIPTION OF THE DRAWINGS

FIG. 1 is a perspective view of a disc head slider, as viewed from a bearing surface, which illustrates cross and crown curvature.

FIG. 2 is a perspective view of a disc head slider, as viewed from a bearing surface, which illustrates twist curvature.

FIG. 3 is a schematic plan view of a disc head slider, as viewed from a bearing surface, which illustrates a shape of the bearing surface.

FIG. 4 is a flow chart illustrating a slider fabrication process.

FIG. 5 is a diagram of an apparatus for adjusting the crown and cross curvature according to one embodiment of the present invention.

FIG. 6 is a flow chart illustrating a slider fabrication process according to one embodiment of the present invention.

FIG. 7 is a schematic view of a bitmap measurement of a bearing surface of a slider.

FIGS. 8-11 are schematic views of shape adjust patterns according to the present invention.

FIGS. 12-15 are models representing responses corresponding to the shape adjust patterns illustrated in FIGS. 8-11, respectively.

FIG. 16 is a model illustrating a resultant shape using a method of the present invention and a desired shape.

FIG. 17 is a model illustrating a resultant shape using a prior art method and a desired shape.

FIG. 18 is a view of a back surface of a slider illustrating an experimental burn mark.

FIG. 19 is a graph illustrating a linear response region resulting from the experimental burn mark illustrated in FIG. 18.

FIG. 20 is a view of a back surface of a slider illustrating an experimental burn mark.

FIG. 21 is a graph illustrating a linear response region resulting from the experimental burn mark illustrated in FIG. 20.

### DETAILED DESCRIPTION OF ILLUSTRATIVE EMBODIMENTS

One embodiment of the present invention utilizes an apparatus to selectively alter material stresses on a back surface of a slider in order to achieve a desired shape on a bearing surface. The desired shape is divided into a collection of shapes that serve as base shapes to form (i.e. through linear superposition) the desired shape. Through experimentation, patterns (i.e. laser burn patterns) on the back surface may be chosen that result in a response (i.e. a change in shape) of the bearing surface in order to achieve the desired shape. Each pattern results in a response on the bearing surface.

In one embodiment, the density of scan lines in a particular pattern leads to a degree of response on the bearing surface. Depending on the desired shape and the collection of shapes that form the desired shape, a collection of patterns can be chosen to fabricate the slider to the desired shape.

Instead of measuring curvature of the slider as an input to burning patterns on the back surface, a representation of the slider shape is generated and used. The representation uses a plurality of measurements that cover substantially the entire bearing surface. Using the burn patterns and the representation, a more precise bearing surface shape is obtained. In addition, it is easier to fabricate sliders with reduced thickness. Those skilled in the art will appreciate that references to the bearing surface and the back surface or working surface are interchangeable in accordance with embodiments of the present invention.

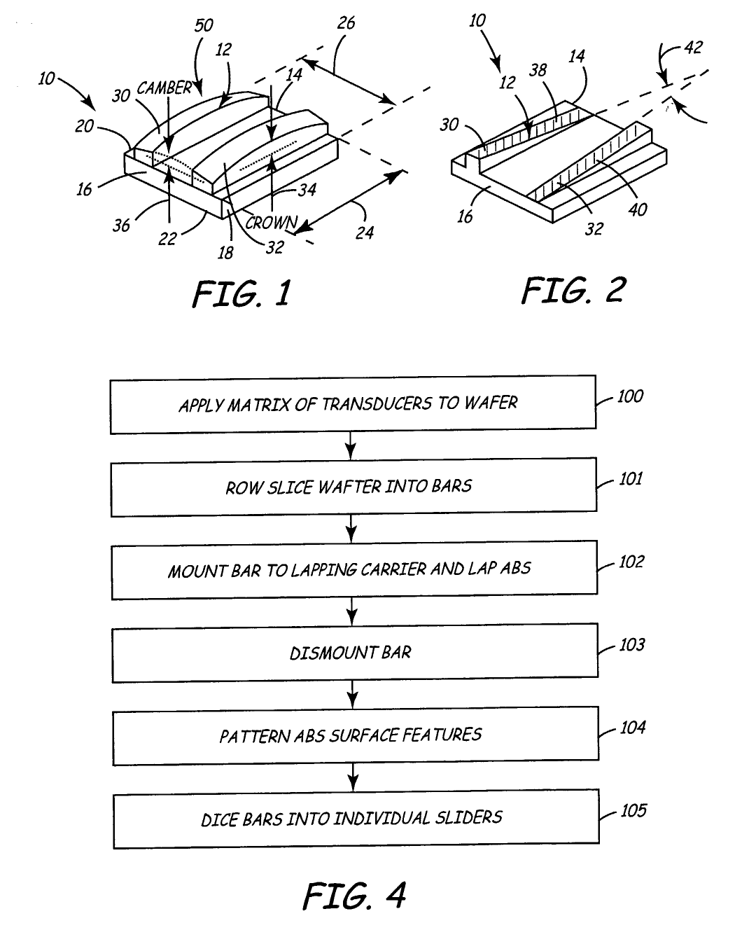

FIG. 1 is a perspective view of a disc head slider 10 as viewed from a bearing surface 12. Bearing surface 12 has a shape 50. Slider 10 has leading edge 14, a trailing edge 16, side edges 18 and 20 and back surface 22. Slider 10 has a length 24, measured from leading edge 14 to trailing edge 16, and a width 26, measured from side edge 18 to side edge 20. Slider 10 also includes a thickness measured from bearing surface 12 to back surface 22 along side edges 18 and 20. In the embodiment shown in FIG. 1, bearing surface 12 includes side rails 30 and 32. However, slider 10 can include a variety of bearing surface geometry. The surface geometry can be configured for a non-contact, direct-contact or pseudo contact recording. Slider 10 carries a read/write transducer (not shown), which is typically mounted along trailing edge 16, but can be positioned at other locations at slider 10 in alternative embodiments. Slider 10 illustratively has a positive curvature along length 24 and width 26. “Crown” curvatures of measure of the curvature of bearing surface 12 along length 24. Crown curvature is negative for a concave surface, positive for a convex surface and zero for a flat surface. “Cross” curvature is a measure of the curvature of bearing surface 12 along width 26. The side of the cross curvature has the same convention as the side of the crown curvature. Cross curvature is also known as “camber” curvature. A common method of measuring the crown and cross curvatures is to measure the differences 34 and 36 between the highest points along length 24 and width 26 and the lowest points along length 24 and width 26. Typical crown and cross curvatures are on the order of 0 to 1.5 micro inches for a “30 series” slider having a length of 49 mills and a width of 39 mills. Slider 10 has a thickness in the range of about 6-12 mills.

Along with a positive crown and cross curvature, it is often desired that slider 10 has a desired “twist”. In one embodiment, slider 10 has no twist. Twist is the tilt between rails 30 and 32, along slider length 24, which can be caused by stresses in the slider substrate material. FIG. 2 is a perspective view of slider 10 illustrating twist along slider length 24. The amount of twist can be measured by fitting planes 38 and 42, the bearing surfaces of rails 30 and 32 and measuring an angle 42 between the fitted plane 38 and 40. The sign of angle 42 indicates the direction of twist and the relative orientation of the rails to each other.

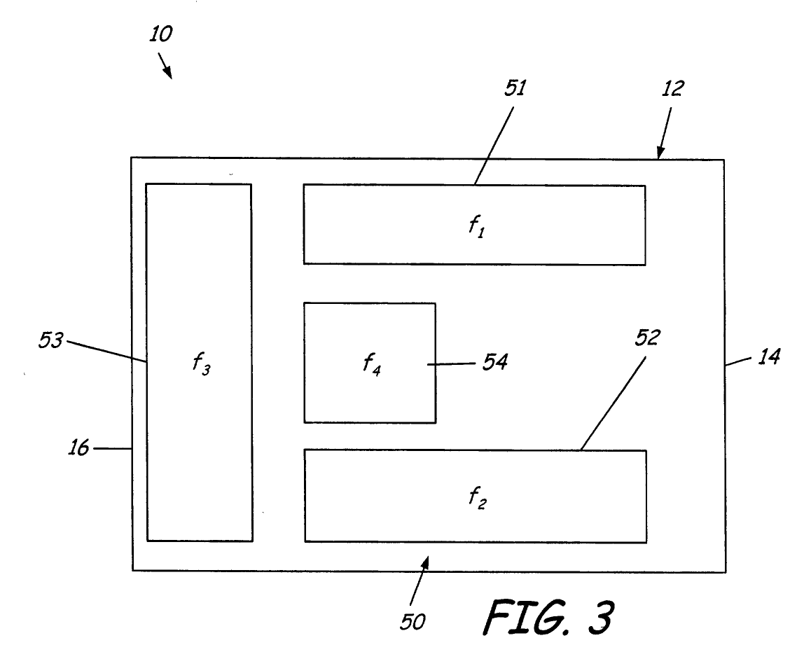

In addition to the crown curvature, cross curvature and twist, slider 10 may possess a bearing surface 12 that has a desired shape depending upon the application of slider 10. As illustrated in FIG. 3, a schematic view of slider 10 illustrates bearing surface 12 having a desired shape 50. Shape 50 is defined by functions 51, 52, 53 and 54. Functions 51-54 illustratively may relate to cross curvature, crown curvature, twist and/or various shapes contributing to the shape of bearing surface 12 and serve as a collection of base shapes that form a desired shape. Generally, the functions correspond to a burn pattern on working surface 22 of slider 10, which are determined by experiment. Areas not covered by one of the functions 51-54 are illustratively a default height. Although illustrated separately, functions 51-54 may overlap. Thus, a particular area on the bearing surface may be defined by more than one function. The functions serve as a basis for forming the shape of a slider. For example, it may be desired to focus on a shape near trailing edge 16, where fly height is more sensitive to slider shape variation than other regions. The functions 51-54 may be a variety of different shapes and sizes and can be expressed as functions pertaining to the bearing surface. Illustratively, the functions (i.e. functions 51-54) may relate to a response area on bearing surface 12 that is used to measure the shape of the slider. In another mode, the response area is substantially the entire slider bearing surface shape.

The shape of slider 10 is controlled according to the present invention during fabrication of the slider body. FIG. 4 is a flow chart illustrating a slider fabrication process according to one embodiment of the present invention. The slider body is formed from a substrate known as a wafer. At step 100, a matrix of transducers is applied to the top surface of the wafer. At step 101, the wafer is sliced along rows into a plurality of bars. The slicing operation is typically performed with a diamond-tipped saw blade or wheel. Each bar includes a plurality of individual slider bodies, with each slider body having a corresponding transducer. The sliced surfaces become bearing surface 12 and back surface 22, while the top surface of the wafer becomes trailing edge 16 of each slider body. The slicing process induces surface stress in bearing surface 12 and back surface 22 due to plastic deformation of the surfaces. This surface stress is typically compressive. In addition, the slicing wheel can form marks on bearing surface 12 and back surface 22 due to misalignment of the wheel and wheel vibration. Therefore, following the slicing operation, bearing surface 12 and back surface 22 are referred to as “rough sliced surfaces”.

At step 102, each bar is mounted to a carrier, and the bearing surface 12 of each bar is machined by a lapping process prior to forming the bearing features. The lapping process is controlled to obtain a target throat height or target resistance for each transducer. At step 103, the bar is dismounted from the lapping carrier. At step 104, the bearing surface features are patterned by ion milling, chemical etching or reactive ion etching (RIE), for example, with one or more masking operations. Once the bearing surface features have been formed, the bars are diced along a plurality of diced lanes into individual slider bodies, at step 105. The diced surfaces become side edges 18 and 20 shown in FIG. 1. The dicing operations can also induce surface stress in side edges 18 and 20. The stresses in the slider substrate material following the above fabrication steps cause each slider body to have some initial or “incoming” shape, which is typically not a desired shape. The initial shape is then adjusted by altering the surface stresses on each slider according to the present invention.

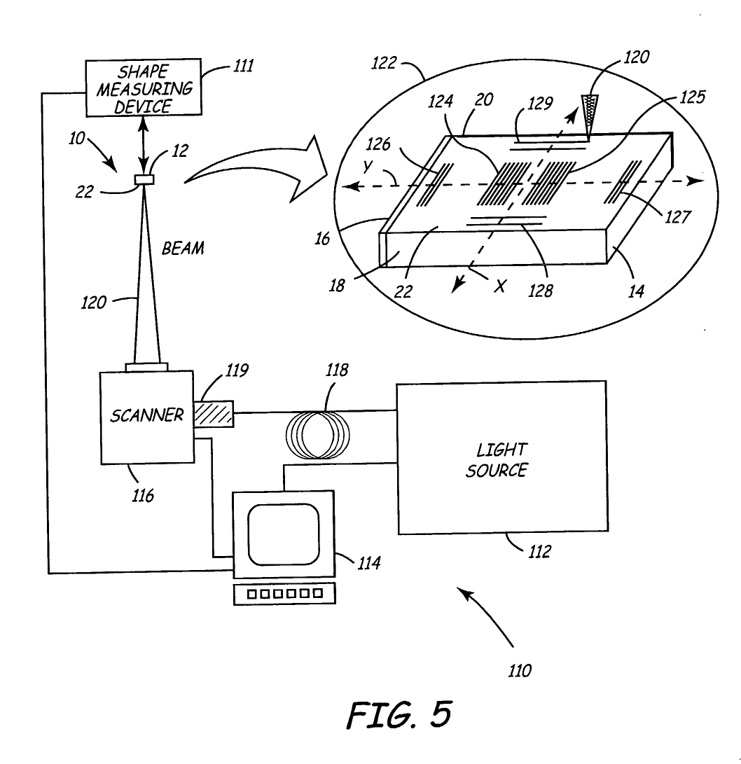

FIG. 5 is a diagram of an apparatus 110 for adjusting the shape of each slider 10 toward target shape values according to predetermined specifications. Apparatus 110 includes shape measuring device 111, light source 112, programmed computer 114, and scanner 116. Programmed computer 114 operates measuring device 111, light source 112, and scanner 116 according to a sequence of instructions stored in a memory (not shown), which is associated with the computer, and user commands provided by a user through a user interface (also not shown). The sequence of instructions, when executed by computer 114, cause apparatus 110 to measure the shape of bearing surface 12 with shape measuring device 111 and then alter the surface stresses on the back surface 22 (or alternatively bearing surface 12) of slider 10, based on the shape measurements, the predetermined target shape for slider 10 and predetermined shape response characteristics. In one embodiment of the present invention, apparatus 110 has one or more slider “nests” (not shown), wherein each nest holds a plurality of sliders 10 for treatment. Each slider is sequentially moved into a working position relative to light beam 120 and shape measuring device 111. Measuring device 111 can include an interferometer, for example, which is capable of producing accurate and repeatable shape measurements (i.e. “gauge capable”).

Apparatus 110 alters the surface stresses on back surface 22 by scanning light beam 120 across back surface 22 of slider 10 in a selected pattern that is chosen to achieve desired curvature change in bearing surface 12. In one embodiment, light source 112 is a fiber laser source, which generates coherent light having continuous power at a wave length of about 1100 nm, which is delivered to scanner 116 over a 5 micrometer fiber-optic cable 118, for example.

Fiber-optic cable 118 is coupled to scanner 116 through a system of lenses 119, which expand the 0.5 mm diameter beam to a collimated beam of about 8 mm in diameter, for example. Scanner 116 passes the 8mm beam through a two-axis galvanometer and then focuses the beam on back surface 22 through a flat-field objective lens. The two-axis galvanometer includes a set of two mirrors that allow planar x-y motion of the focused beam on the working surface of slider 10. Exemplary line patterns are illustrated on back surface 22 of slider 10 as scan lines 125, 126, 127, 128 and 129.

There are numerous pre-existing conditions that influence the shape response in bearing surface 12 from the scan lines produced by beam 120. These conditions include the post-slice surface condition of the slider, the slicing wheel type, the laser and scanner settings, the type of slider substrate material, the thickness of the substrate, the slider-burn pattern alignment, status of the slider as a “rework” or “non-rework” slider, the desired shape targets and shape functions of incoming sliders.

With respect to the post-slice surface condition of a particular slider, row slice surfaces (the bearing surface and the back surface) that show rough marks tend to absorb more of the laser power. Thus, the heat affected zone of each scan line will be wider, resulting in a proportionally greater response in the shape change. In a typical process, rough sliders may constitute less than 5% of all sliders treated by apparatus 110. High shape responses can be attributed to excessive shear stresses produced during the slicing operation. For example, some rough sliders have been observed to have a shape response that is 100% greater than a normal shape response. The algorithm implemented by computer 114 significantly reduces the effects of variations in the post-slice surface condition.

The type of wheel used for slicing the wafer into bars of slider bodies produces unique surface conditions on the slider body following the slicing operation. For example, one wheel type may produce a surface that is fairly homogeneous, but may remove a large amount of compressive surface stress on which the laser heat treatment can act as compared to another wheel type.

The power setting on the laser and the speed setting on the scanner also greatly influence the resulting shape. In one embodiment, neither the power nor the speed is used as a process variable for effecting a desired shape change since the response is insensitive to changes in power and speed beyond certain values. In addition, at lower speed values, the burn pattern dimensions are extremely sensitive to changes in scanning speed due to the small area of the slider's back surface. Using either of these variables as a process variable may result in unstable design finctions since the burn lines change both in depth and width for each new value of the variable. Thus, a two-dimensional change can not be predicted by one variable.

The substrate type also influences the shape response for a given laser treatment. For, example, a typical slider is formed from a substrate of Al₂O₃—TiC. If the substrate type is changed, new power and scanning speed settings may be required, along with new design finctions (i.e. design curves) and/or a new laser system may be needed. Additionally, thickness of the slider is a variable that effects shape response. Using the method described below, sliders with thicknesses in the range of about 6-12 mills can be fabricated to desired shapes. In one embodiment, the slider thickness is in the range of about 6-10 mills. In another embodiment, the thickness is in the range of about 7-9 mills.

Since the position of each laser scan line on the sliders back surface has an effect on the resulting shape change, variations in alignment from one slider to the next will also influence the shape response. The shape control algorithm implemented by computer 114 accounts for alignment variations. The sources of alignment variations includes tolerances from one nest to the next and from one apparatus to the next. For nest-to-nest variations, a cross pattern is burned at the center of a slider for all nests.

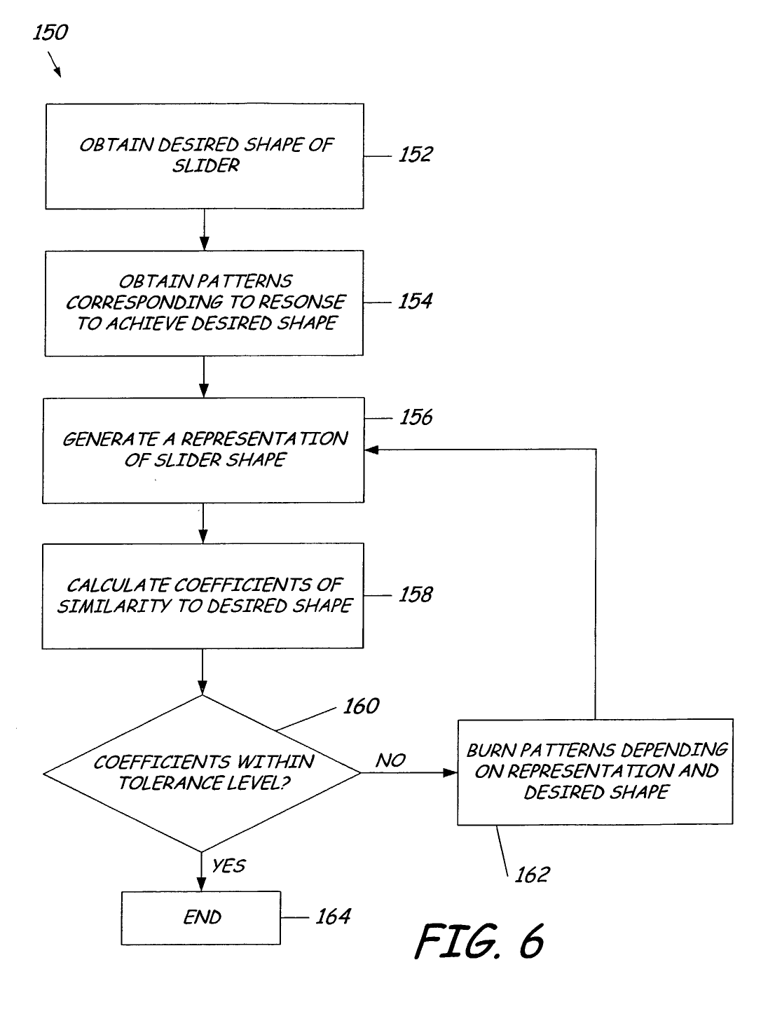

It should further be noted that apparatus 110 can be used to determine and select burn patterns for similar sliders. Patterns are burned on the slider working surface and a response is measured. The response measured and the corresponding burn pattern can be stored on computer 114 for later use during fabrication of sliders. Using the stored patterns, a collection of patterns may be established that achieve a desired shape. This collection is used in method 150 as described in relation to FIG. 6.

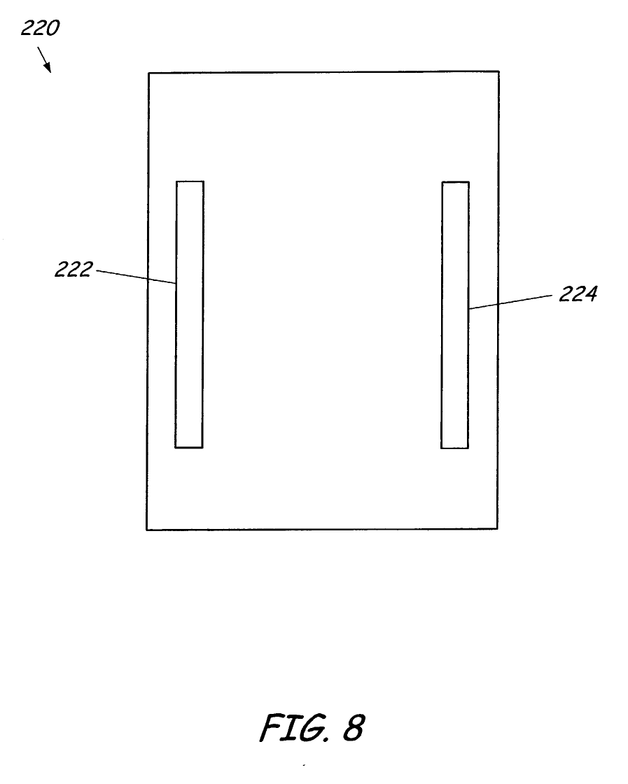

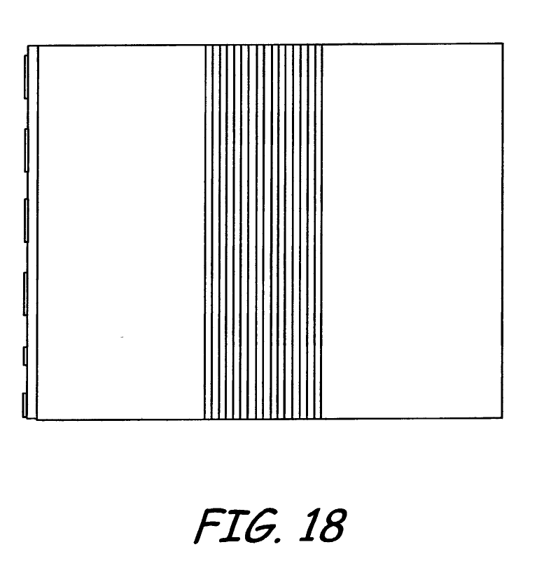

FIG. 6 illustrates a method 150 for use in modifying a shape of slider 10 according to one embodiment of the present invention. Method 150 includes obtaining a desired shape of slider 10 at step 152. The desired shape may be any surface shape and be defined by cross curvature, crown curvature and twist. Alternatively, the desired shape may be defined by various functions, such as functions 51-54. The desired shape (i.e. the functions that define the desired shape) is stored on a computer and serves as the basis to fabricate the slider body for a particular slider application. After the desired shape is obtained, shape adjusts patterns corresponding to a response to achieve the desired shape are obtained at step 154. The patterns are predetermined and generally stored on a computer. The patterns correspond to an area on a back surface of the slider that generate a response on the bearing surface of the slider. The response is also predetermined and it is achieved by experimentation. Generally, a linear response region is also calculated in which the response for a given pattern is substantially linear for a particular burn line density range. The linear response region is discussed with respect to FIGS. 18-21. Exemplary shape adjust patterns are illustrated in FIGS. 8-11.

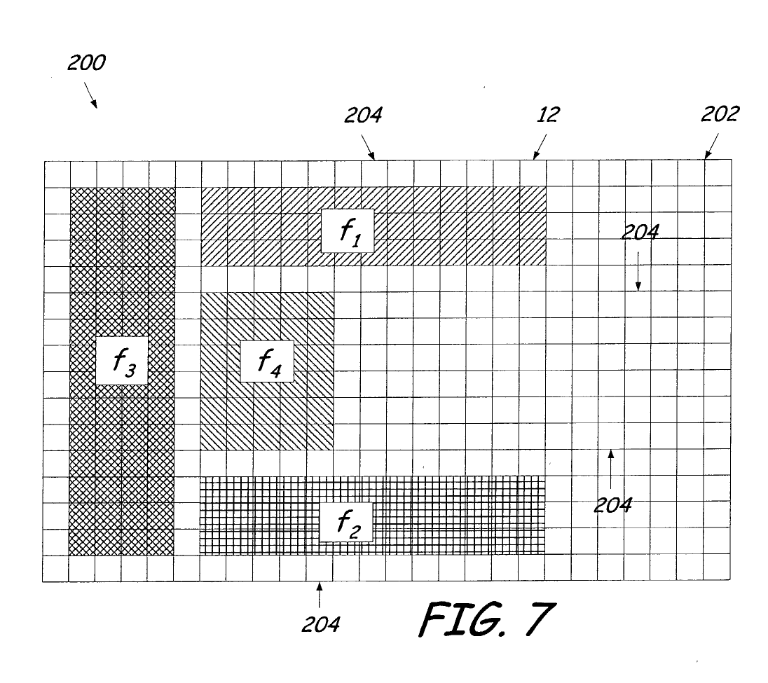

Next, at step 156, a representation of the slider shape is generated. The representation corresponds to the specific shape of the slider being measured. The representation includes a plurality of measurements. The plurality of measurements measure at least substantially a response area related to a particular function of the desired shape and typically measure substantially the entire bearing surface. Thus, the representation does not merely measure the crown and/or cross curvature. The plurality of measurements define the representation and are used to provide a determination of how close the present bearing surface is to the desired shape. In one mode of operation, the representation is a bitmap measurement of the bearing surface. The bitmap measurement corresponds to a bearing surface array. FIG. 7 illustrates a bitmap measurement 200. Measurement 200 includes a bearing surface array 202 including a plurality of individual pixels 204. Together, the plurality of pixels 204 in the bearing surface array 202 substantially cover the entire bearing surface 12. The plurality of pixels 204 pertain to a unit area on the bearing surface 12 and include a height measurement of the particular area. The bitmap measurement provides a precise measurement of the bearing surface shape and is utilized in achieving the desired shape.

Next, at step 158, coefficients (or indications) of similarity to the functions of the desired shape are calculated according to the representation (i.e. bitmap measurement 200). In one embodiment, the coefficients are associated with a particular function of the desired shape and are determined using a least square surface fitting method. Thus, the shape of the slider being measured from the representation can be expressed as:

S(x,y)=a₀+a₁*x+b₁*y+C₁*f₁(x,y)+C₂*f₂(x,y)+C₃*f₃(x,y)+ . . . +Cₙ*fₙ(x,y).

The first three terms represent a general orientation of the slider. The remaining terms represent calculations of the present shape. At step 160, a determination is made as to whether coefficients C₁ through Cₙ are within a particular tolerance level (i.e. how closely C₁ Cₙ correspond to the desired shape). If the coefficients are not within the tolerance level, the shape adjust patterns previously obtained are burned on a working surface of the slider according to various parameters in order to adjust the coefficients to desired levels. Coefficients C₁-Cₙ of each of the functions f₁-fₙ represent a degree of response on the bearing surface. For example, a higher coefficient C₁ means a greater response of f₁ is desired. In one embodiment, the scan line density in a pattern area is increased to drive the present slider coefficients (C₁-Cₙ) to desired levels to achieve the desired shape.

In addition to other parameters, the representation and the desired shape are inputs to develop the particular pattern and density that is used to shape the slider. By using the representation as input used when altering material stresses on the back surface 22, a more precise slider shape may be achieved. For example, once a representation is established, it may be desired to burn a single pattern or (or only those patterns with corresponding coefficients not within a tolerance level) since each of the other coefficients are within a tolerance level. Once the patterns have been burned, the method returns to step 156 in order to achieve another representation. Steps 156, 158, 160 and 162 are repeated until the coefficients are within a particular tolerance level. Once the coefficients are within the tolerance level, the process ends at step 164.

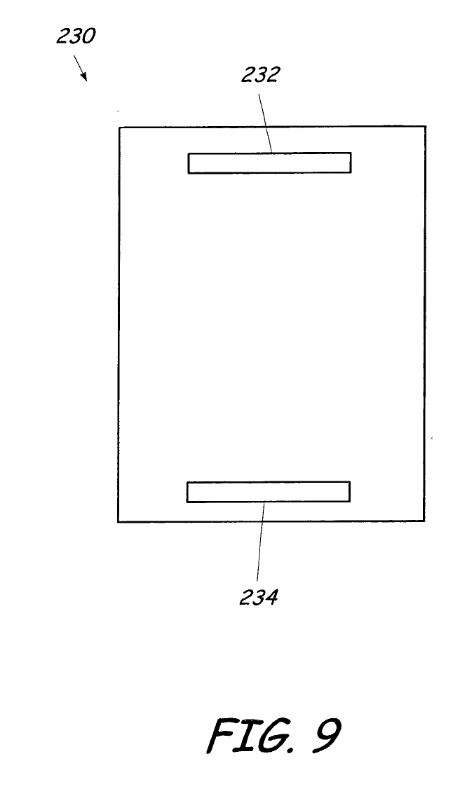

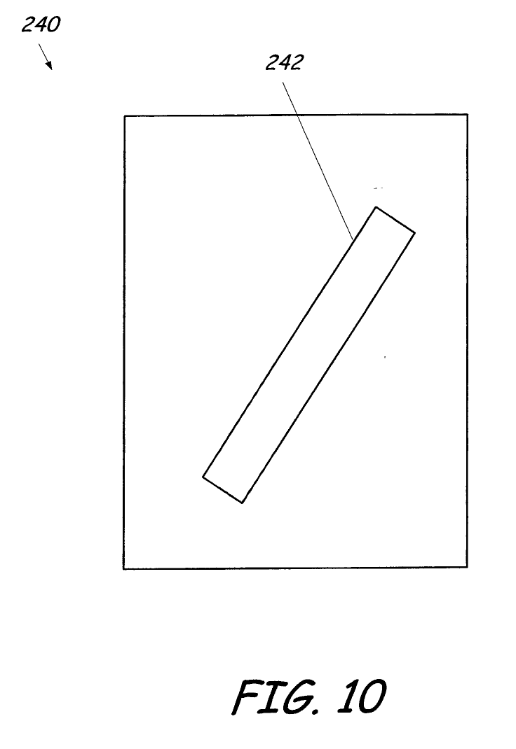

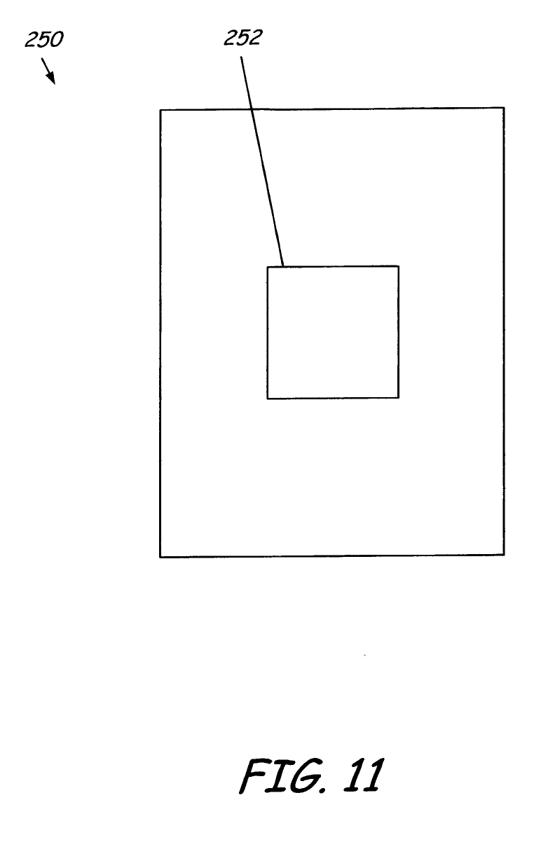

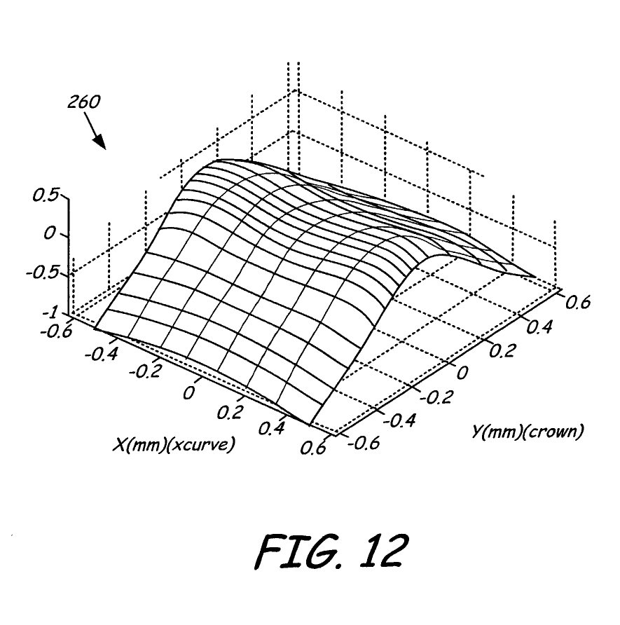

FIGS. 8 through 11 illustrate exemplary shape adjust patterns for use in method 150 of FIG. 6. Each of the burn patterns contributes to a response on the bearing surface of the slider. The burn patterns are predetermined and used during fabrication according to the responses measured from burning the selected patterns. FIG. 8 illustrates a pattern 220 contributing to crown curvature of the slider while FIG. 9 illustrates a pattern 230 contributing substantially to cross curvature of the slider. FIG. 10 illustrates a pattern 240 contributing substantially to twist of the slider and FIG. 11 illustrates a pattern 250 corresponding substantially to a center response. FIGS. 12 through 15 illustrate models of the responses for the burn patterns illustrated in FIGS. 8 through 11, respectively.

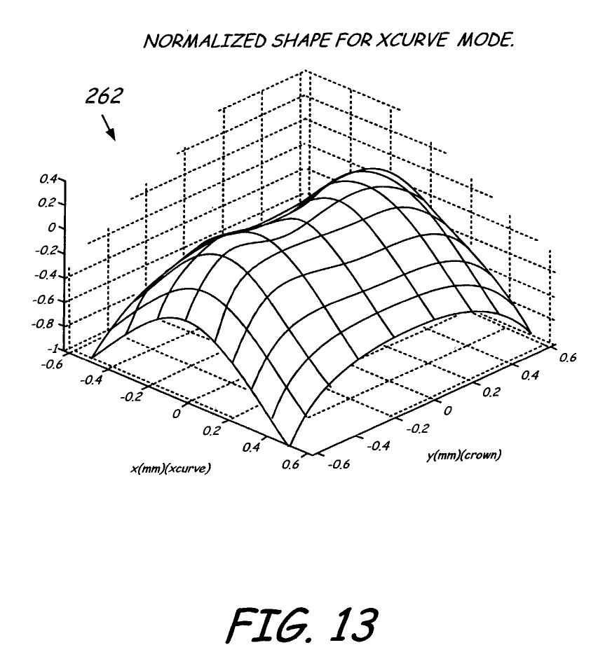

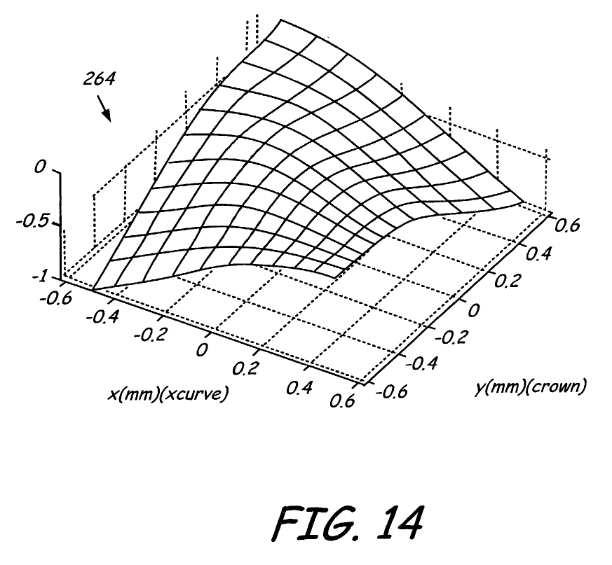

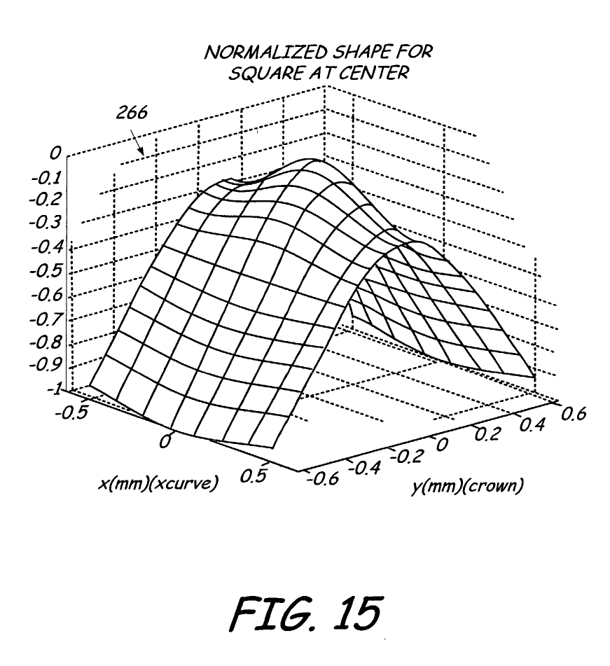

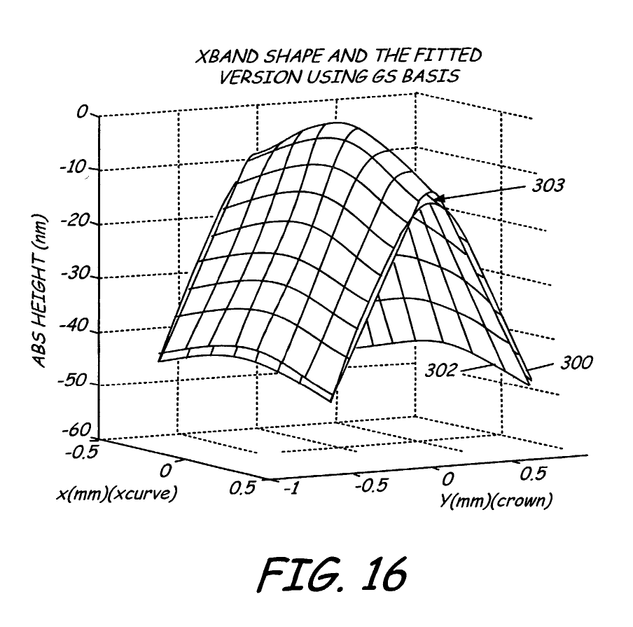

Collectively, the responses of the shape adjust patterns illustrated in FIGS. 8-11 serve as a basis (or alternatively a collection of base shapes) for producing a desired shape of a slider. The response for each shape adjust patterns may be calculated by experimentation and the overall shape calculated by linear superposition of the responses. For example, the model illustrated in FIG. 12 is the response 260 resulting from burning the shape adjust pattern 220 illustrated in FIG. 8. Areas 222 and 224 are illustratively burnt with at least one laser scan line. Generally, the response 260 illustrated in FIG. 12 is of a crown curvature. Similarly, FIG. 13 illustrates a response 262 for the shape adjust pattern 230 illustrated in FIG. 9. Areas 232 and 234 are burnt with at least one laser scan line to achieve response 262. This response 262 contributes to a cross curvature. FIG. 14 illustrates a twist mode response 264 to the shape adjust pattern 240 illustrated in FIG. 10. Area 242 is burnt to achieve response 264. FIG. 15 illustrates a center response 266 to the shape adjust pattern 250 of FIG. 16. Burning area 252 achieves the center response 266.

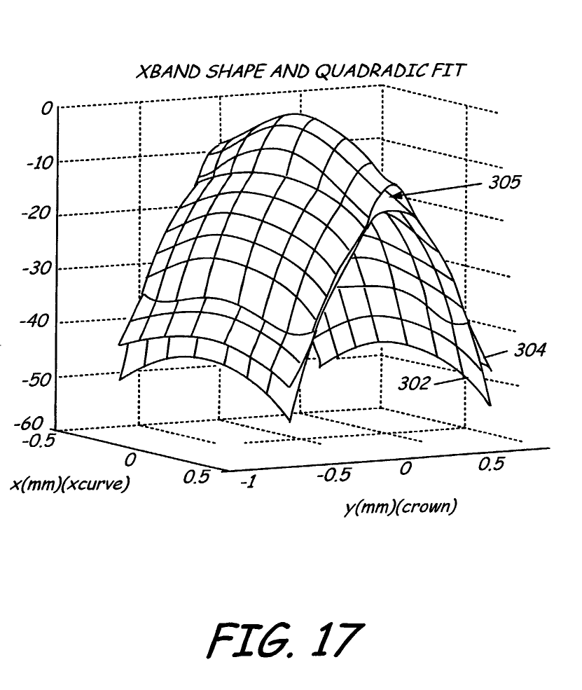

When the shape adjust patterns illustrated in FIGS. 8 through 11 were used in accordance with method 150, a shape 300 illustrated in FIG. 16 can be obtained, which is a collection of the responses illustrated in FIGS. 12-15. The shape 300 closely corresponds to a desired shape 302. Accordingly, a more precise shape for slider 10 is achieved. Accordingly, discrepancy 303 (i.e. a difference in the shapes) is small. In contrast, FIG. 17 illustrates shape 304 that does not closely correspond to desired shape 302. Shape 304 was generated using only measurements of crown curvature and cross curvature to change the shape of the slider. The discrepancy 305 between shape 304 and 302 is not desirable in low fly height situations.

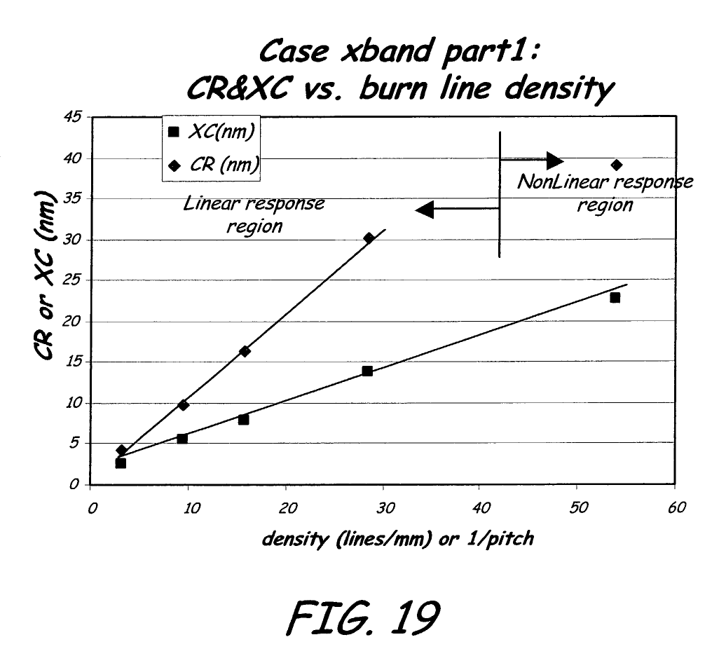

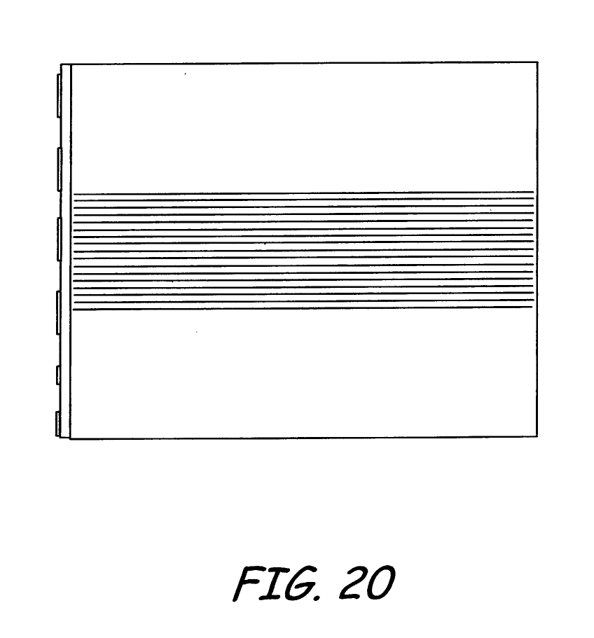

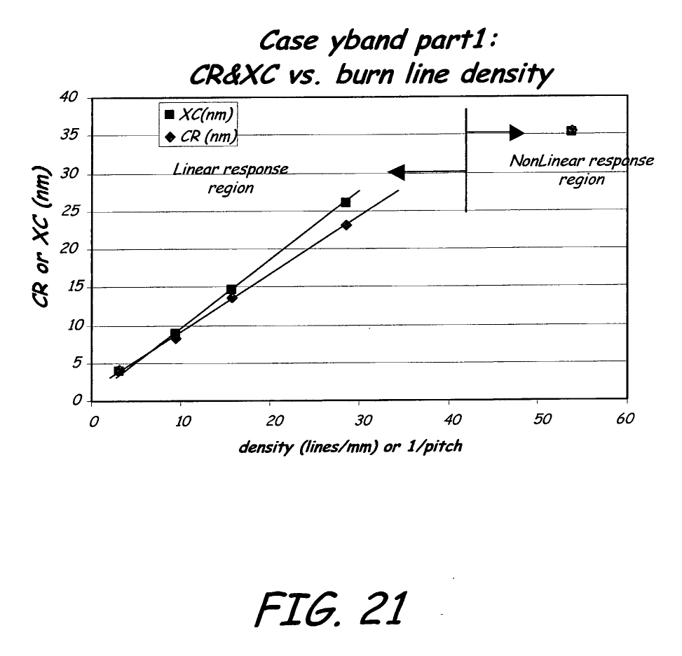

In order to establish control input parameters for the respective burn patterns, experiments were conducted. FIG. 18 illustrates an experiment burn area extending from one side edge to another side edge of a slider. FIG. 19 illustrates a graph of crown and cross curvature in relation to a particular density of burn lines. As illustrated, both the crown and cross curvature have a linear response when the line density is 29 lines per millimeter or less. Accordingly, burn line density in a burn area (i.e. a shape adjust pattern) can be a good candidate for control input and to achieve desired coefficients for respective responses. Thus, with an increase in burn lines density, an increase in shape response results. FIG. 20 illustrates burn lines extending from a leading edge to a trailing edge of a slider. As illustrated in FIG. 21, both the crown and cross curvatures have a generally linear response when the density is less than or equal to 29 lines per millimeter. Accordingly, when establishing particular patterns to achieve a desired shape, a linear response can be assumed if the lines density is less than 29 lines per millimeters in one embodiment of the present invention.

In summary, a method (150) of controlling a shape (50, 300) of a bearing surface (12) of a head slider (10) is provided. The method (150) includes obtaining (154) a set of shape adjust patterns (220, 230, 240, 250), wherein each pattern corresponds to a response (260, 262, 264, 266) in the shape (50, 300) of the bearing surface (12). Furthermore, the method (150) includes generating (156) a representation (200) of the shape (50, 300) of the bearing surface (12) of the slider (10). The representation (200) includes a plurality of measurements of substantially the entire shape (50, 300) of the bearing surface (12) wherein each measurement corresponds to a location (204) on the bearing surface (12) and a height of the associated location (204). Material stresses on a working surface (22) of the slider (10) are selectively altered (162) within the obtained shape adjust patterns (220, 230, 240, 250) based on the representation (200) in order to alter the shape (50) of the bearing surface (12).

Another aspect of the invention is a head slider (10). The slider (10) includes a first surface (12) having a shape (50, 300) defined by a collection of base shapes (260, 262, 264, 266) and a second surface (22) opposite the first surface (12). A set of shape adjust patterns (220, 230, 240, 250) are included on the second surface (22), wherein each shape adjust pattern (220, 230, 240, 250) corresponds to one of the collection of base shapes (260, 262, 264, 266). Additionally, a selected number of scan lines are formed within each of the shape adjust patterns (220, 230, 240, 250) on the second surface (22). Each scan line generates a degree of response on the first surface (12) of one of the collection of base shapes (260, 262, 264, 266) associated with the shape adjust pattern (220, 230, 240, 250).

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the read/write head while maintaining substantially the same functionality without departing from the scope and spirit of the present invention. References made to the bearing surface and back surface or working surface are interchangeable in accordance with embodiments of the present invention. In addition, although the preferred embodiment described herein is directed to a head for a hard disc drive system, it will be appreciated by those skilled in the art that the teachings of the present invention can be applied to other storage and magnetic systems, like tape drives, without departing from the scope and spirit of the present invention.

What is claimed is:

1. A method of controlling a shape of a bearing surface of a head slider, the method comprising:
obtaining a set of shape adjust patterns, wherein each pattern corresponds to a response in the shape of the bearing surface;
generating a representation of the shape of the bearing surface of the slider wherein the representation includes a plurality of measurements of substantially the entire shape of the bearing surface, each measurement corresponding to a location on the bearing surface and a height of the associated location; and
selectively altering material stresses on a working surface of the slider within the obtained shape adjust patterns based on the representation to alter the shape of the bearing surface.

2. The method of claim 1 and further comprising:
obtaining a desired shape of the slider; and
calculating an indication corresponding to a difference between the desired shape and the representation.

3. The method of claim 2 wherein generating the representation comprises:
measuring the representation as:
S(x,y)=a₀+a₁*x+b₁*y+C₁*f₁(x,y)+C₂*f₂(x,y)+ . . . +Cₙ*fₙ(x,y);
wherein,
a₀, a₁, *x, b₁ * y represent the general orientation of the head,
f₁(x,y), f₂(x,y), . . . , fₙ(x,y) represent a collection of functions corresponding to the set of shape adjust patterns, and
C₁, C₂, . . . , Cₙ represent the indications and are coefficients related to degree of response to respective functions.

4. The method of claim 3 and further comprising:
only altering material stresses in the shape adjust patterns where the
corresponding coefficients are not within an acceptable level.

5. The method of claim 4 wherein the coefficients are calculated using a least squares calculation method.

6. The method of claim 2 and further comprising:
checking whether the indication is within a tolerance level.

7. The method of claim 6 and further comprising:
repeatedly altering material stresses on the working surface of the slider until the indication is within the tolerance level.

8. The method of claim 7 wherein the step of altering includes increasing the burn line density in the shape adjust patterns until the indication is within the tolerance level.

9. The method of claim 1 and further comprising:
calculating a linear response region, wherein the linear response region pertains to a burn line density in at least one of the shape adjust patterns corresponding to a substantially linear response in shape of the bearing surface.

10. The method of claim 1 wherein selectively altering material stresses includes selectively scanning a laser beam spot along the working surface of the slider to form at least one laser scan line within at least one of the shape adjust patterns.

11. The method of claim 10 wherein selectively scanning a laser beam spot includes forming at least one laser scan line within each shape adjust pattern.

12. The method of claim 1 wherein the representation comprises:
a bitmap measurement of the shape of the bearing surface, wherein the bitmap measurement corresponds to a bearing surface array, the bearing surface array including a plurality of pixels substantially covering the entire bearing surface, each pixel corresponding to an area on the bearing surface and a height of the associated area.

13. The method of claim 1 wherein at least one of the shape adjust patterns contributes substantially to a crown curvature response.

14. The method of claim 1 wherein at least one of the shape adjust patterns contributes substantially to a cross curvature response.

15. The method of claim 1 wherein at least one of the shape adjust patterns contributes substantially to a twist response.

16. The method of claim 1 wherein at least one of the shape adjust patterns contributes substantially to a center response.

17. A head slider fabricated according to the method of claim 1.

18. A head slider, comprising:
a first surface having a shape defined by a collection of base shapes;
a second surface opposite the first surface;
a set of shape adjust patterns on the second surface, wherein each shape adjust pattern corresponds to one of the collection of base shapes; and
a selected number of scan lines formed within each of the shape adjust patterns on the second surface, each scan line generating a degree of response on the first surface of one of the collection of base shapes associated with the shape adjust pattern.

19. The slider of claim 18 wherein at least one of the shape adjust patterns contributes substantially to a crown curvature response on the first surface.

20. The slider of claim 18 wherein at least one of the shape adjust patterns contributes substantially to a cross curvature response on the first surface.

21. The slider of claim 18 wherein at least one of the shape adjust patterns contributes substantially to a twist response on the first surface.

22. The slider of claim 18 wherein at least one of the shape adjust patterns contributes substantially to a center response on the first surface.

23. The slider of claim 18 and further comprising first and second side edges between the first and second surfaces, wherein a thickness of the first and second side edges is about 8 mills.

24. The slider of claim 18 and further comprising first and second side edges between the first and second surfaces, wherein a thickness of the first and second side edges is in the range of about 6-10 mills.

25. The slider of claim 18 wherein the shape of the first surface is represented as:
S(x,y)=a₀+a₁*x+b₁*y+C₁*f₁(x,y)+C₂*f₂(x,y) + . . . +C*fₙ(x,y);
wherein,
a₀, a₁, *x, b₁ * y represent the general orientation of the head,
f₁(x,y), f₂(x,y), . . . , fₙ(x,y) represent a collection of functions corresponding to the collection of base shapes, and
C₁, C₂, . . . , Cₙ represent coefficients of a degree of shape change of the collection of functions that result from the number of scan lines formed in the shape adjust patterns.
